(19) United States
(12) Patent Application Publication
(10) Pub. No.: US 2016/0208685 A1
(43) Pub. Date: Jul. 21, 2016

(54) PORTABLE ENGINE-DRIVEN WORKING MACHINE

(71) Applicant: YAMABIKO CORPORATION, Tokyo (JP)

(72) Inventors: Hiroyuki MIYAKI, Tokyo (JP); Takamasa OTSUJI, Tokyo (JP); Shirou YAMAGUCHI, Tokyo (JP)

(21) Appl. No.: 14/995,906

(22) Filed: Jan. 14, 2016

(30) Foreign Application Priority Data
Jan. 20, 2015 (JP) 2015-008651

(51) Int. Cl. F02B 63/02

(52) U.S. Cl. CPC F02B 63/02

(57) ABSTRACT

A portable engine-driven working machine has an engine unit and a cover enclosing the engine unit. The engine unit includes a cylinder block, an electronically controlled carburetor, a controller connected to the carburetor and a diagnostic connector connected to the controller. The cover has a cylinder cover partially defining a first chamber containing the cylinder block and partially defining a passage for air which cools the cylinder block, and a removable connector cover partially defining a second chamber containing the diagnostic connector.

### TECHNICAL FIELD

The present invention relates to a portable engine-driven working machine, specifically to a portable engine-driven working machine such as a chain saw, a brush cutter, a hedge trimmer and so on.

### BACKGROUND ART

A portable engine-driven working machine having an electronically controlled carburetor is known (refer to, for example, Patent Publication 1). Such an electronically controlled carburetor includes a solenoid valve for controlling a feed of fuel, the solenoid valve being an actuator for adjusting an operation state of the engine-driven working machine. For example, ON and OFF timings of the solenoid valve is controlled by a controller mounted on the engine-driven working machine so as to address a regulation for exhausted gas from the engine and operate the working machine efficiently.

In such an electronically controlled engine-driven working machine, in order to confirm a controlled state and existence or non-existence of failure by the controller and adjust the controller (modify a program of the controller), a diagnostic connector to be connected to an external diagnostic tool is wired from the controller.

### PRIOR ART PUBLICATION

Patent Publication 1: U.S. Patent Application Publication No. 2008/0041146

### SUMMARY OF THE INVENTION

### Problem to be Solved by the Invention

There is a conventional working machine in which a diagnostic connector is provided adjacent to a cylinder block of an engine. The cylinder block including a combustion chamber in which a mixture consisting of fuel and air is combusted becomes a high temperature during the operation of the working machine. Then, in order to cool the cylinder block, it is necessary to attach a cylinder cover around the cylinder block to flow a cooling air between the cylinder block and the cylinder cover. Further, for safety for an operator, the cylinder cover has a structure so that it cannot be removed without a tool. Thus, it is necessary to remove the cylinder cover with a tool for connecting the diagnostic tool to the diagnostic connector and this bothers the operator.

Further, since the cylinder cover is removed when the diagnostic tool is connected to the diagnostic connector, the cylinder block cannot be cooled as during a practical operation. Thus, if the diagnostic tool is used while the working machine is operating with the cylinder cover removed, the controlled states of the working machine which is operating during conditions different from those during the actual operations would be confirmed.

It is therefore an object of the present invention that a portable engine-driven working machine in which a diagnostic tool can be connected to a diagnostic connector without removing a cylinder cover and the diagnostic tool can be used with the cylinder cover attached.

### Means for Solving the Problem

In order to achieve the above-stated object, a portable engine-driven working machine according to the present invention has an engine unit, and a cover enclosing the engine unit; wherein the engine unit includes a cylinder block, an actuator for adjusting an operating state of the engine-driven working machine, a controller connected to the actuator, and a diagnostic connector connected to the controller, and wherein the cover has a cylinder cover partially defining a first chamber containing at least the cylinder block and partially defining a passage for air which cools the cylinder block, and a removable connector cover partially defining a second chamber partitioned from the first chamber and containing at least the diagnostic connector.

In this portable engine-driven working machine, the cylinder block is contained in a first chamber partially defined by the cylinder cover, while the diagnostic connector is contained in the second chamber partially defined by the connector cover. As a result, by removing the connector cover without removing the cylinder cover, the diagnostic tool can be connected to the diagnostic connector. Further, in a state in which the cylinder cover is attached, namely, in a state in which the cylinder block is cooled by flowing air for cooling the cylinder block between the cylinder block and the cylinder cover, as a practical operation, the diagnostic tool can be connected to the diagnostic connector and used.

In an embodiment of the portable engine-driven working machine according to the present invention, preferably, the cylinder cover is removable only by using a tool, while the connector cover is removable without using a tool.

In this portable engine-driven working machine, the cylinder cover can be only intentionally removed with a tool in order to prevent the operator from the cylinder block which may become a high temperature, while the connector cover can be easily removed without using a tool in order to easily connect the diagnostic tool to the diagnostic connector.

In an embodiment of the portable engine-driven working machine according to the present invention, preferably, an orientation of the diagnostic connector is determined so that when the connector cover is removed, a diagnostic tool can be connected from a location, where the connector cover existed, toward the diagnostic connector.

In this portable engine-driven working machine, without changing the orientation of the diagnostic connector, the diagnostic tool can be easily connected to the diagnostic connector. Namely, comparing with a case in which the diagnostic connector is laterally attached to an anchor with respect to the connecting direction of the diagnostic tool, operations of removing the diagnostic connector from the anchor and changing the orientation of the diagnostic connector can be omitted.

In an embodiment of the portable engine-driven working machine according to the present invention, preferably, the engine unit further has an air cleaner contained in the second chamber. More preferably, the air cleaner can be replaced by removing the connector cover.

In this portable engine-driven working machine, both of the diagnostic connector and the air cleaner are contained in the second chamber. Thus, especially in a case in which the air cleaner is originally contained in the second chamber, by modifying the design so as to add the diagnostic connector to the second chamber, the diagnostic tool can be easily connected to the diagnostic connector. Further, when the cover is originally ready for replacing the air cleaner, an additional cover is not necessary by using the cover also as the connector cover.

Further, when the air cleaner becomes dirty or clogged, a rotational speed of the engine is decreased so that an output performance of the engine is changed. If the controller is adjusted after a controlled state in which the air cleaner is dirty or clogged is confirmed and based on this confirmation, the working machine with engine could not be operated in an optimum state. Further, when cleaning or replacement of the air cleaner is performed at a different timing from adjustment of the controller, the engine-driven working machine may not operate in an optimum state. If both the diagnostic connector and the air cleaner are located in the second chamber, when the diagnostic tool is connected to the diagnostic connector, the contamination or clog of the air cleaner can be checked. If necessary, the engine-driven working machine can be surly operated in an optimum state by cleaning or replacing the air cleaner.

In an embodiment of the portable engine-driven working machine according to the present invention, preferably, the actuator is one or more of a solenoid valve for feeding fuel to an electronically controlled carburetor, an ignition coil, and a solenoid valve for fuel injection.

The portable engine-driven working machine according to the present invention is preferably a chain saw.

According to the portable engine-driven working machine according to the present invention, without removing the cylinder cover, the diagnostic tool can be connected to the diagnostic connector and the diagnostic tool can be used in a state in which the cylinder cover is attached.

### BRIEF DESCRIPTION OF THE DRAWINGS

FIG. 1 is a front view of a chain saw according to the present invention with a cover shown in a cross-sectional view.

FIG. 2 is a plan view of the chain saw according to the present invention with a cover omitted.

### DESCRIPTION OF EMBODIMENTS

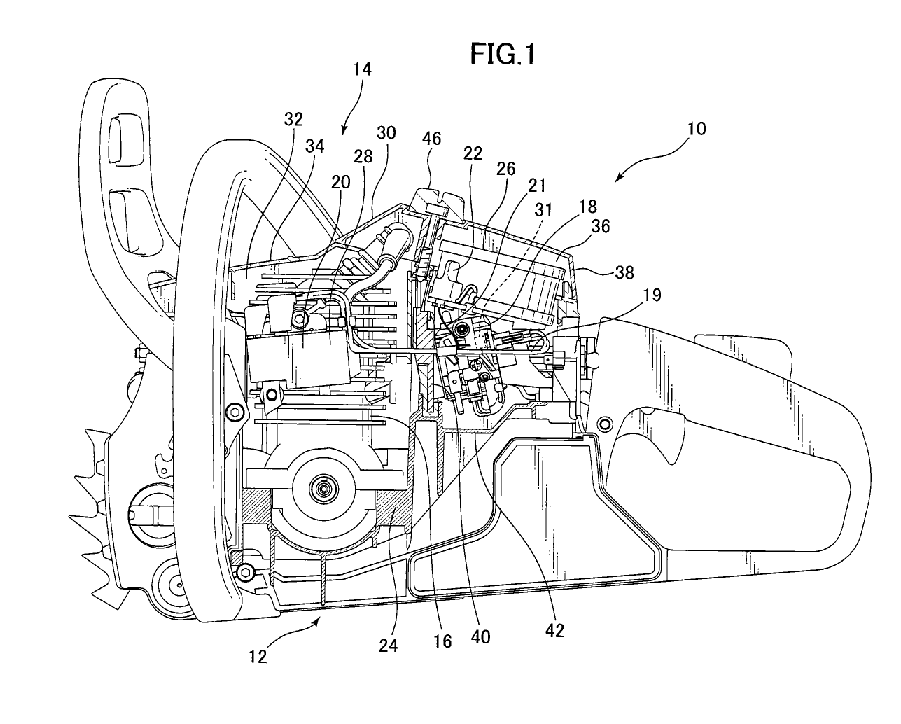

Referring to the drawings, a chain saw, which is an embodiment of a portable engine-driven working machine according to the present invention, will now be explained. As shown in FIG. 1, a chain saw 10 has an engine unit 12 which is operated with gasoline fuel, and a cover 14 enclosing the engine unit 12. In FIG. 1, a chain blade is omitted.

The engine unit 12 has, at least, a cylinder block 16, an electronically controlled carburetor 18 which is an actuator for controlling an operating state of the engine-driven working machine, a controller 20 connected to the carburetor 18 via a lead wire 19, a diagnostic connector 22 connected to the controller 20 via a lead wire 21, and a frame 24 to which these components 16, 18, 20, 22 are attached. The engine unit 12 further has an intake air cleaner 26.

The cylinder block 16 includes a combustion chamber (not shown) and is configured so that a mixture consisting of fuel and air is suctioned into the combustion chamber and the mixture in the combustion chamber (not shown) is combusted by applying a voltage generated by an ignition coil 28 to an ignition plug 28.

The electronically controlled carburetor 18 includes a solenoid valve 31 for controlling a feed of fuel into the carburetor 18. The controller 20 is configured to control ON timing and OFF timing of the solenoid valve 31. In the present embodiment, the controller 20 is integrated into the ignition coil 28.

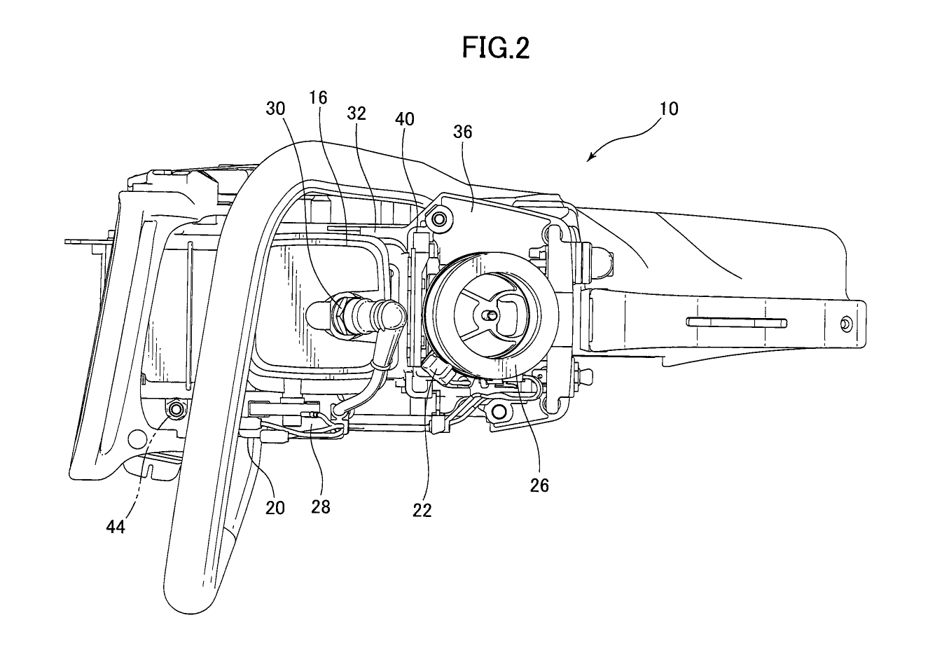

The diagnostic connector 22 is a connector to which a diagnostic tool (not shown) for diagnosing an operation of the working machine is connected. In FIG. 1 and FIG. 2, the diagnostic connector 22 with a terminal cover for protecting terminals is shown. An orientation of the diagnostic connector 22 is preferably determined so that when the connector cover 38 is removed, the terminal cover is removable toward a location where the connector cover 38 existed. Further, the orientation of the diagnostic connector 22 is preferably determined so that the diagnostic tool can be connected from a location where the connector cover 38 existed toward the diagnostic connector 22.

The cover 14 has a cylinder cover 34 partially defining a first chamber 32 which contains at least a cylinder block 16, and a connector cover 38 partially defining a second chamber 36 which is partitioned from the first chamber 32 and contains the diagnostic connector 22. In the present embodiment, the first chamber 32 is defined by the frame 24 and the cylinder cover 34, while the second chamber 36 is defined by the frame 24, the cylinder cover 34 and the connector cover 38. Specifically, a portion of a wall partitioning the first chamber 32 and the second chamber 36 from each other is defined by the cylinder cover 34. The cylinder cover 34 is disposed around the cylinder block 16 and partially defines a passage for air which flows between the cylinder cover 34 and the cylinder block 16 so as to cool the cylinder block 16.

The first chamber 32 concretely contains the cylinder block 16, the ignition coil 28, a portion of the ignition plug 30, and the controller 20. The second chamber 36 concretely contains the carburetor 18, the air cleaner 26 and the diagnostic connector 36. In order to define the first chamber 32 and the second chamber 36, the frame 24 has a bulkhead 40 extending vertically adjacent to the cylinder block 16, and a bulkhead 42 extending laterally from a lower portion of the bulkhead 40.

The cylinder cover 34 can be fixed and removed with respect to the frame 24 only when a tool is used. Concretely, the cylinder cover 34 is configured to be fixed to the frame 24 with bolts 44 (shown in FIG. 2), and these bolts 44 could not be fastened and loosed if a wrench and so on is not used.

The connector cover 38 can be fixed and removed with respect to the frame 24 without any tools. Concretely, the connector cover 38 is fixed to the frame 24 with a knob which is rotatable with a hand.

Next, an operation of the chain saw which is an embodiment of a portable engine-driven working machine according to the present invention will be explained.

A space between the cylinder cover 34 and the cylinder block 16 defines a flow passage for air which cools the cylinder block 16, and the cooling air cools the cylinder block 16 at a high temperature. When the diagnostic tool (not shown) is used, the knob 46 is turned with a hand to remove the connector cover 38 so that the second chamber 36 is at least partially opened to connect the diagnostic tool to the diagnostic connector 22. Since the diagnostic connector 22 is not located in an area adjacent to the cylinder block 16, the cylinder cover 34 does not need to be removed so that the diagnostic tool and the diagnostic connector 22 can be easily connected to each other. In the present embodiment, since the connector cover 38 also serves as an air cleaner cover, by removing the connector cover 38, the air cleaner 26 can be replaced.

Further, since the diagnostic tool can be used in a state in which the cylinder cover 24 is attached, namely, in a practical state in which the working machine 10 is operating while the cylinder block 16 is cooled, the operating and controlled states of the chain saw 10 can be confirmed accurately in real time. Especially, when a control is performed with a temperature condition and so on of the cylinder block 16, more accurate controlled states can be obtained and can be reflected in the control. Further, the cylinder cover 34 prevents the operator from contacting the cylinder block 16 at a high temperature.

It is especially preferable that the confirmation of the controlled states of the chain saw 10 is performed while the chain saw 10 is operating, as explained above. However, the controller 20 may be configured to store the controlled states and the diagnostic tool may be configured to read the stored controlled states.

Further, when the diagnostic tool is connected to the diagnostic connector 22, contamination or clog of the air cleaner 26 is preferably checked. When the air cleaner 26 becomes dirty or clogged, a rotational speed of the chain saw 10 is decreased so that an output performance of the engine is changed. Further, if the controller 20 is adjusted in a state when the air cleaner 26 is dirty or clogged, the chain saw 10 may not be operated in an optimal state. If the air cleaner 26 is dirty or clogged when the diagnostic tool is connected to the diagnostic connector 22, by adjusting the controller 20 after the air cleaner 26 is cleaned or replaced, the chain saw 10 can be surely operated in an optimal state.

Although the embodiments of the present invention have been explained, the present invention is not limited to the above-stated embodiments, namely, a various modifications are possible within the scope of the present invention recited in the claims. It goes without saying that such modifications are also within the scope of the present invention.

Although in the above-stated embodiment, the embodiment of the chain saw has been explained, a portable engine-driven working machine according to the present invention may be other engine-driven working machines, such as a brush cutter, a hedge trimmer, and a power blower (fan).

The first chamber 32 is not necessarily defined only by the frame 24 and the cylinder cover 34, namely, may be defined with other pieces. The second chamber 36 is arbitrarily defined so long as the diagnostic connector 22 is accessible by removing the connector cover 38 without removing the cylinder cover 34. For example, the second chamber 36 may be defined by the frame 24, the cylinder cover 34 and the connector cover 38 or by the cylinder cover 34 and the connector cover 38. In the latter case, the cylinder cover 34 is configured to be prevented from being removed unless the connector cover 38 is removed. Further, the second chamber 36 may be defined so as to include a large cover with a window and a connector cover covering over the window.

Although in the above-stated embodiment, the diagnostic connector 22 is disposed in the same chamber as the air cleaner 26, it may be disposed in the same chamber as the other components.

Although in the above-stated embodiment, the fuel-feeding solenoid valve of the electronically controlled carburetor has been explained as an example of an actuator for adjusting an operating state of the engine-driven working machine, such an actuator may be an ignition coil, a solenoid valve for a fuel injection nozzle, or a combination thereof.

What is claimed:

1. A portable engine-driven working machine, comprising:
an engine unit, and
a cover enclosing the engine unit,
wherein the engine unit includes a cylinder block, an actuator for adjusting an operating state of the engine-driven working machine, a controller connected to the actuator, and a diagnostic connector connected to the controller,
wherein the cover has a cylinder cover partially defining a first chamber containing at least the cylinder block and partially defining a passage for air which cools the cylinder block, and a removable connector cover partially defining a second chamber partitioned from the first chamber and containing at least the diagnostic connector.

2. The engine-driven working machine according to claim 1,
wherein the cylinder cover is removable only by using a tool, while the connector cover is removable without using a tool.

3. The engine-driven working machine according to claim 1,
wherein an orientation of the diagnostic connector is determined so that when the connector cover is removed, a diagnostic tool can be connected from a location, where the connector cover existed, toward the diagnostic connector.

4. The engine-driven working machine according to claim 1,
wherein the engine unit further has an air cleaner contained in the second chamber.

5. The engine-driven working machine according to claim 4,
wherein the air cleaner can be replaced by removing the connector cover.

6. The engine-driven working machine according to claim 1,
wherein the actuator is one or more of a solenoid valve for feeding fuel to an electronically controlled carburetor, an ignition coil, and a solenoid valve for fuel injection.

7. The engine-driven working machine according to claim 1,
wherein the working machine is a chain saw.
